(19) United States
(12) Patent Application Publication
(10) Pub. No.: US 2026/0262784 A1
(43) Pub. Date: Sep. 10, 2026

(54) INSOLE STRUCTURE FOR SHOES WITH ENHANCED HEALTH FUNCTION

(71) Applicant: SHOEALLS CO., LTD., Cheonan-si (KR)

(72) Inventors: Cheonggn LEE, Cheonan-si (KR); Kyungho KIM, Busan (KR); Youngkyong LEE, Yangsan-si (KR)

(21) Appl. No.: 19/321,060

(22) Filed: Sep. 5, 2025

(30) Foreign Application Priority Data
Nov. 18, 2024 (KR) 10-2024-0164494

(51) Int. Cl. A43B 7/30; A43B 17/00; A61H 23/02

(52) U.S. Cl. CPC A43B 7/30; A43B 17/00; A61H 23/02; A61H 2201/1642; A61H 2201/165; A61H 2205/12

(57) ABSTRACT

The present invention provides an insole for shoes for improving health function, a lower surface of which comprising a flat base, and a support surface including a gently sloped portion extending integrally from the base, wherein: a first heel pad for supporting the heel is attached to the rear portion of the support surface of the base, the first heel pad has point-symmetrical graphics, and is attached so that the thickness of the first side surface is identical to the thickness of the second side surface, or the thickness of the first side surface differs from the thickness of the second side surface, and thus, a thicker portion is positioned on the inner side of the foot and a thinner portion is positioned on the outer side of the foot, or due to 180 degree rotation, the thicker portion is positioned on the outer side of the foot, and the thinner portion is positioned on the inner side of the foot, thereby enabling the first pad to attach in accordance with the body type of O-shaped or X-shaped legs.

### TECHNICAL FIELD

The present invention relates to an insole structure for shoes with enhanced health function.

### BACKGROUND

Insoles for shoes are items put on the bottom of shoes. Without an insole, the foot is positioned directly on the shoe's sole, which reduces wearability and comfortableness, and the foot is not properly fixed and thus gets easily fatigued. To walk normally, insoles may be considered as an essential item. When purchasing shoes, insoles are always included, and sometimes they may be integrated with the midsole or attached using adhesives.

Insoles are just as important as the shoes themselves so as to be called the second shoe, and must be designed to match the shape, size, and skeletal structure of the foot. Insoles can relieve plantar fasciitis and flat foot pain, eliminate foot fatigue, and provide corrective support not only for the sole of the foot but also from the feet to the waist. Reflecting the importance of insoles, many functional insoles are available on the market, but it is difficult to choose an economical product that is ergonomically designed across the entire upper and lower surfaces of the insole.

The structure of the sole in contact with the insole is the same as shown in FIG. 9. The curve from the rear of the sole to the inner point where the thick portion of the forefoot begins is called an inside longitudinal arch, the curve from the rear of the sole to the outer point where the thick portion of the forefoot begins is called an outside longitudinal arch, and the line connecting the inside and outside points is called the forefoot transverse arch. The inside longitudinal arch and the outside longitudinal arch have an arc shape with the apex at the center, but the inside longitudinal arch has a relatively smaller radius of curvature (i.e., it curves upward more significantly) and has a relatively larger distance from the upper surface of the insole. Insoles are also fabricated in accordance with the structure of foot, but it is proposed that multiple pads is used to adapt to the skeletal structure of the sole

For example, Korean Patent No. 10-1746521 discloses an insole that provides a customized balance-maintaining pads based on the degree of arch collapse according to flat feet, pronated feet, and talipes cavus, wherein the insole comprises a shoe insole 10′, an insole main body 20′, an inside heel pad 30′, an outside heel pad 40′, an inside longitudinal arch pad 50′, an outside longitudinal arch pad 60′, an inside metarsal bone pad 70′, an outside metatarsal bone pad 80′, and a transverse arch pad 90′ as shown in FIG. 10. However, this patent has the disadvantage that it is difficult to fabricate because pads must be attached to almost the entire bottom surface of the insole in order to address all foot structures other than those of a normal person's sole, and it is difficult to determine which insole should be used for any specific recovery function.

Prior patents disclose pads for cases where foot sole is not normal, such as flat feet and talipes cavus, but they do not disclose functional pads hat can assist feet supporting bow-legged O-shaped legs or splayed X-shaped legs.

The present invention relates to devising an insole structure for shoes with enhanced health function by further improving the structures of the aforementioned prior patents and prior arts.

### DETAILED DESCRIPTION OF THE INVENTION

### Technical Problem

Therefore, it is an object of the present invention to provide an insole structure for shoes that improves health function, is suitable for the foot structure of the human body, and is general-purpose and universally usable for O-shaped legs and X-shaped legs.

### Technical Solution

In order to achieve the above object, an aspect of the present invention provides an insole for shoes for improving health function, a lower surface of which comprising a flat base, and a support surface including a gently sloped portion extending integrally from the base, wherein: a first heel pad for supporting the heel is attached to a rear portion of the support surface of the base, the first heel pad has point-symmetrical graphics, and is attached so that the thickness of the first side surface is identical to the thickness of the second side surface, or the thickness of the first side surface differs from the thickness of the second side surface, and thus, a thicker portion is positioned on the inner side of the foot and a thinner portion is positioned on the outer side of the foot, or due to 180 degree rotation, the thicker portion is positioned on the outer side of the foot, and the thinner portion is positioned on the inner side of the foot, thereby enabling the first hell pad to attach in accordance with the body type of O-shaped or X-shaped legs.

Another aspect of the present invention provides an insole for shoes for improving health function, a lower surface of which comprising a flat base, and a support surface including a gently sloped portion extending integrally from the base, wherein: a ball-of-foot pad is attached to a forefoot portion of the base where the ball of foot is located, the ball-of-foot pad has point-symmetrical graphics, and is attached so that the thickness of the first side surface is identical to the thickness of the second side surface, or the thickness of the first side surface differs from the thickness of the second side surface, and thus, a thicker portion is positioned on the inner side of the foot and a thinner portion is positioned on the outer side of the foot, or due to 180 degree rotation, the thicker portion is positioned on the outer side of the foot, and the thinner portion is positioned on the inner side of the foot, thereby enabling the ball-of-foot pad to attach in accordance with the body type of O-shaped or X-shaped legs.

Yet another aspect of the present invention provides an insole for shoes for improving health function, a lower surface of which comprising a flat base, and a support surface including a gently sloped portion extending integrally from the base, wherein: at least one ball-of-foot pad is attached to the base, and a first heel pad for supporting the heel is attached to a rear portion of the support surface, the first heel pad is attached so that the thickness of the first side surface is identical to the thickness of the second side surface, or the thickness of the first side surface differs from the thickness of the second side surface, and thus, a thicker portion is positioned on the inner side of the foot and a thinner portion is positioned on the outer side of the foot, or on the contrary, the thicker portion is positioned on the outer side of the foot, and the thinner portion is positioned on the inner side of the foot, thereby enabling the first heel pad to attach in accordance with the body type of O-shaped or X-shaped legs.

The at least one ball-of-foot pad is attached so that the thickness of the first side surface is identical to the thickness of the second side surface, or the thickness of the first side surface differs from the thickness of the second side surface, and thus, a thicker portion is positioned on the inner side of the foot and a thinner portion is positioned on the outer side of the foot, or on the contrary, the thicker portion is positioned on the outer side of the foot, and the thinner portion is positioned on the inner side of the foot, thereby enabling the ball-of-foot pad to attach in accordance with the body type of O-shaped or X-shaped legs.

A lattice-shaped reinforcement portion composed of curved horizontal ribs and curved vertical ribs may be formed at an intermediate region from the support surface on the lower surface to the portion where the first heel pad is located.

An upper surface of the insole comprises a flat base, and a support surface including a gently sloped portion extending integrally from the base, wherein: a first pad may be attached at a position overlapping with the inside longitudinal arch line, spanning the inside edge and the sloped surface on the upper surface of the insole, and a second pad may be attached to the center in the left-right direction at a position overlapping with the forefoot transverse arch line that connects the inside longitudinal arch end point and the outside longitudinal arch end point.

The first pad and the second pad may have a structure in which the height is highest at the center and decreases toward the ends.

The insole is mounted with a vibration device, the vibration device is configured such that magnets are fixed to the upper and lower surfaces of the casing, a vibration plate is mounted in the middle of the casing, and movable magnets are positioned at the ends of the vibration plate so that they face the magnets on the upper and lower surfaces, the upper and lower surfaces of each magnet are arranged with the same polarity to generate a repulsive force, so that the vibration plate vibrates as the wearer moves, thereby applying vibrations to the soles of the wearer's feet and helping to improve blood flow.

A further aspect of the present invention provides an insole for shoes for improving health function, the insole comprising a flat base, and a support surface including a gently sloped portion extending integrally from the base, wherein: a first pad is attached so that it overlaps with the inside longitudinal arch line at an intermediate point in the longitudinal direction of the support surface, from the inside edge to the sloped surface on the upper surface of the insole, at least a boundary region between the base and the support surface is included toward the front of the foot on the upper surface of the insole, and a second pad is attached to the portion overlapping with the forefoot transverse arch line that connects the inside longitudinal arch end point and the outside longitudinal arch end point, a ball-of-foot pad is attached to the base of the lower surface of the insole, the rear side of the support surface on the lower surface of the insole is formed with a first heel pad that supports the heel portion of the foot, the ball-of-foot pad and the first heel pad have point-symmetrical graphics, and is attached such that the thickness of the first side surface of each pad differs from the thickness of the second side surface opposite to the first side surface, and thus, a thicker portion is positioned on the inner side of the foot and a thinner portion is positioned on the outer side of the foot, or the thicker portion is rotated 180 degrees and positioned on the outer side of the foot, and the thinner portion is positioned on the inner side of the foot, thereby enabling the ball-of-foot pad and the first heel pad to be used without replacing or adding pads in accordance with the body type of O-shaped or X-shaped legs.

### Advantageous Effects

The present invention exhibits the effects that provide an insole structure for shoes that improves health function, is suitable for the foot structure of the human body, and is general-purpose and universally usable for O-shaped legs and X-shaped legs.

### BRIEF DESCRIPTION OF THE DRAWINGS

FIG. 1 is a plan view of the insole for shoes of the present invention, as viewed from above;

FIG. 2 is a side view of the insole for shoes of FIG. 1;

FIG. 3 is a bottom view of the insole of FIG. 1, as viewed from below;

FIG. 4A is a plan view of the first pad, and FIG. 4B is a central cross-sectional view taken along a longer direction from the center of FIG. 4A;

FIG. 5A is a plan view of the second pad, and FIG. 5B is a central cross-sectional view taken along a longer direction from the center of FIG. 5A;

FIG. 6A is a plan view of the first heel pad, and FIGS. 6B to 6D are cross-sectional views of FIG. 6A at various thicknesses;

FIG. 7 is a diagram showing an embodiment in which the first heel pad and the ball-of-foot pad are attached to the lower surface of the insole of the present invention;

FIG. 8 is a diagram showing another embodiment in which the first heel pad and the ball-of-foot pad are attached to the lower surface of the insole of the present invention;

FIG. 9 is a diagram showing the skeletal structure of the sole of the foot; and

FIG. 10 is a bottom view of the insole of the prior patent.

### DETAILED DESCRIPTION OF THE EMBODIMENTS

The present invention is susceptible to various modifications and alternative forms. Therefore, specific embodiments are illustrated in the drawings and specific details for carrying out the invention are described in detail. However, this is not intended to limit the present invention to the particular forms set forth, but on the contrary to cover all modifications, equivalents, and alternatives falling within the spirit and technical scope of the present invention.

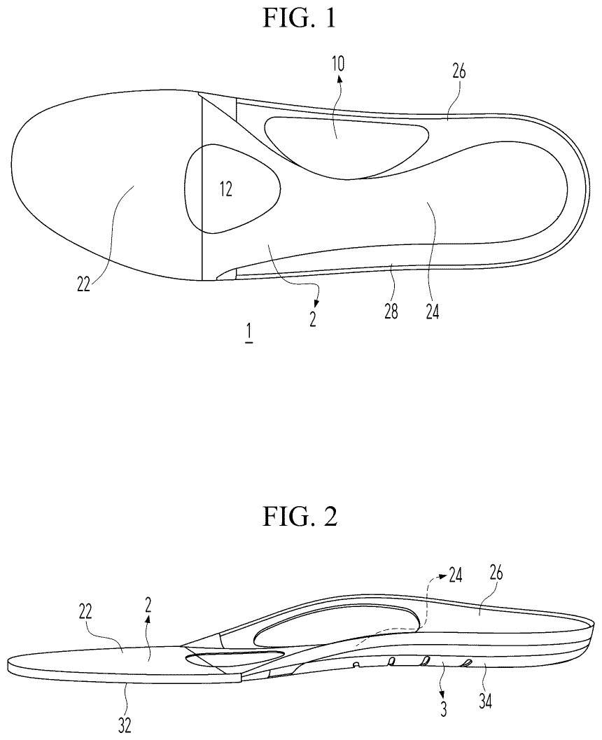

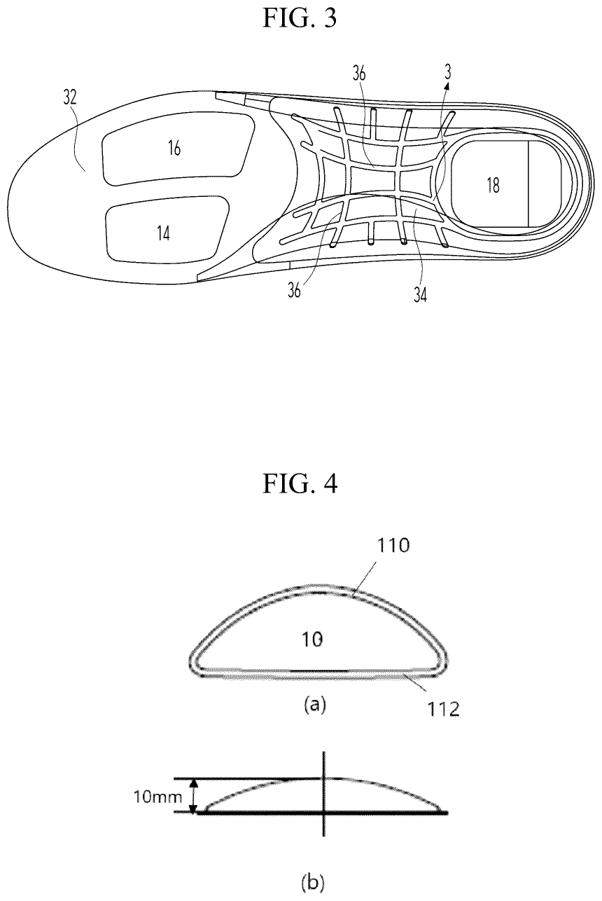

FIG. 1 is a plan view of the insole 1 for shoes of the present invention, as viewed from above; FIG. 2 is a side view of the insole 1 for shoes of FIG. 1; and FIG. 3 is a bottom view of the insole 1 of FIG. 1, as viewed from below. The top of insole 1 is an upper surface 2, and the bottom is a lower surface 3, but the overall appearance shape when viewed from a plan is identical and is tailored to the contours and shape of the foot.

Referring to the figures together, first, the upper surface 2 of the insole 1 in FIG. 1 is depicted based on a left foot, with the lower side of the figure being the outside of the left foot and the upper side being the inside. The left side of the figure represents the forefoot, which is the front of the foot, and the right side represents the heel. The upper surface 2 includes a body designed in accordance with the shape of the sole. The body includes a relatively flat front base 22 and a support surface 34 that extends integrally from the base 22 and has a gently upward portion. The overall length ratio of the base 22 and the support surface 34 is approximately 1:1.5~1:2, but is not limited thereto. The boundary between the base 22 and the support surface 34 preferably include the forefoot transverse arch line, and this is because the sole bones rise in an arch-like shape from the rear based on the forefoot transverse arch line. The support surface 34 rises gently upward from the portion in contact with the base 22, but after exceeding a predetermined length, it is formed as a flat surface (see FIG. 2).

From the edge of the support surface 34, the edges 26, 28 are erected upward to surround the periphery of the support surface 34. The edges 26, 28 adhere to most of the side surface of the foot including the heel, thereby providing a sense of stability to the wearer. The inside edge 26 is preferably higher than the outside edge 28 in accordance with the foot structure.

The insole 1 of the present invention is fabricated three-dimensionally with a flat surface, a gently sloped surface, and an edge, so that it can directly adhere to the sole of the foot and thus provide a sense of stability to the wearer.

A first pad 10 is formed spanning the medial edge 26 and the sloped surface 24 on the upper surface 2 of the insole 1 of the present invention. The first pad 10 is positioned so as to overlap with the inside longitudinal arch line. The position of the first pad 10 overlaps with the inside longitudinal arch line. The first pad 10 is positioned near the intermediate point of the support surface 34 in the longitudinal direction, in which the upper surface is flat and the lower surface is arch-or semicircular-shaped with a rounded curve as shown in FIG. 1. The outer side of the insole 1 is not mounted with a pad along the outside longitudinal arch, as in the prior patents.

A second pad 12 is formed on the upper surface 2 of the insole 1 toward the front of the foot. The mounting location of the second pad 12 includes at least the boundary area between the base 22 and the support surface 34. It also overlaps with the forefoot transverse arch line connecting the end points of the inside longitudinal arch and the outside longitudinal arch, and is formed at the midpoint when viewed in the width direction of the upper surface 2, i.e., at a position that is not biased to the left or right. The second pad 12 has an egg-shaped shape in which the upper surface (left side of the figure) is gently sloping, and both side surfaces converge downward, so that the lower surface (right side of the drawing) is finished with an arc with a small radius of curvature. However, the embodiments are not limited thereto, and appropriate modifications are possible, such as the upper surface being flat, or the entire side and lower surfaces being arched.

The side view of FIG. 2 clearly shows the three-dimensional structure of the insole 1 of the present invention. The base 22 and the support surface 34 of the insole 1 are based on the structure of the sole of the foot, but in the human body, the skeleton descends again near the heel and touches the ground at the tip end of the heel. However, the support surface 34 of the present invention does not have a structure that descends sharply, and instead supports the heel by a flat surface or a very gently rising surface. Thus, the wearer can feel both elasticity and sense of stability at the moment the heel of the foot touches the ground.

FIG. 3 is a direct inversion view of FIG. 1, in which the lower surface 3 of the insole 1 is configured with the lower side of the figure representing the inner side and the upper side representing the outer side, based on the left foot. In FIG. 3, the lower surface 3 of the insole 1 of the present invention is integrated with the upper surface 2, so the base 32 and support surface 34 are identified by different part numbers, and a detailed description thereof will be omitted.

The first ball-of-foot pad 14 and the second ball-of-foot pad 16, which constitute the features of the present invention, are mounted on both the left and right sides of the base 32 on the lower surface 3 of the insole 1. The first and second ball-of-foot pads 14, 16 have a substantially rectangular shape that is narrow in width and long in length, and the second ball-of-foot pad 16, located on the outer side of the foot, is fabricated to be slightly larger. The first and second ball-of-foot pads 14, 16 can be attached by changing the left and right positions, particularly for cases of O-shaped and X-shaped legs.

The first heel pad 18, which supports the heel of the foot, is mounted in a rectangular shape on the rear side of the support surface 34 of the lower surface 3 of the insole 1. The first heel pad 18 is rectangular in shape, slightly wider and longer than the ball-of-foot pad, and is fabricated to have sufficient contact area with the heel.

Additionally, a lattice-shaped reinforcement section 36 consisting of horizontal and vertical ribs is formed in the intermediate region from the support surface 34 to the portion where the first heel pad 18 is located. The horizontal and vertical ribs have a curved arch shape, which efficiently supports the weight of the foot and distributes the load more effectively compared to straight ribs, thereby helping to improve the durability of the insole 1. In particular, in the present invention, the support surface 34 of the insole 1 is designed to elastically support the rear portion of the foot, so the reinforcement portion 36 is necessary to enhance the durability of the insole 1. Further, as shown in FIG. 2, the reinforcement portion 36 is fabricated to a thickness that sufficiently covers the rear portion of the lower surface 3 of the insole 1 to allow the entire insole 1 to be in flat contact with the ground, thereby providing the wearer with the feeling that evenly touches with the ground when wearing the shoe.

As described above, the pads of the present invention can be integrally fabricated by gluing, attaching, assembling, or fusing them to the insole. The pads protrude slightly from the upper or lower surface of the insole and come into direct contact with the sole or shoe. In the present invention, two pads are mounted on the upper surface 2 and three pads are mounted on the lower surface 3 of the insole 1, however these pads do not overlap each other in a planar view.

Therefore, the insole 1 of the present invention utilizes evenly distributed pads to maintain foot health in a balanced and efficient manner.

The following describes pads that constitute other features of the present invention.

FIG. 4A is a plan view of the first pad 10, and FIG. 4B is a central cross-sectional view taken along a longer direction from the center of FIG. 4A. The first pad 10 is fabricated such that the first surface 110 is flat, and the second surface 112 has a rounded arc or arch shape. The first pad 10 at its center has a thickness of 10 mm, 7 mm, 4 mm, etc., and is made highest at its center and thinner toward the edges. FIG. 4B shows an example of a thickness of 10 mm.

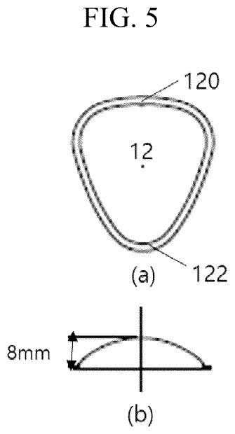

FIG. 5A is a plan view of the second pad 12, and FIG. 5B is a central cross-sectional view taken along a longer direction from the center of FIG. 5A. The second pad 12 has an egg-shaped or inverted triangular shape, with the first surface 120 gently sloping nearly flat, the sides converging downward, and the second surface 122 finishing as an arc with a small radius of curvature. The second pad 12 at its center has a thickness of 8 mm, 6 mm, 4 mm, etc., and is made thickest at the center and thinner toward the edges. FIG. 5B shows an example of a thickness of 8 mm.

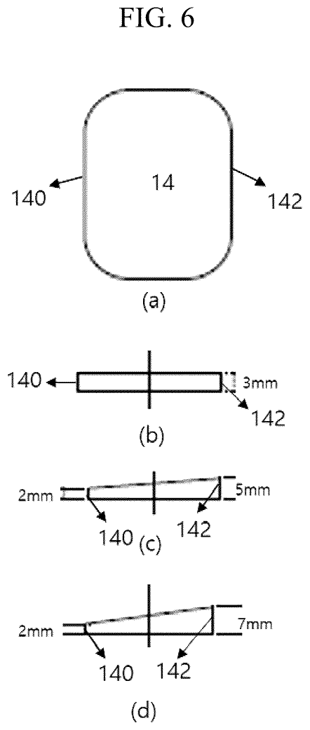

FIG. 6A is a plan view of the first ball-of-foot pad 14, and FIGS. 6B to 6D are cross-sectional views of FIG. 6A at various thicknesses, illustrating features of the present invention. The shape of the first ball-of-foot pad 14 is not particularly limited, but the thickness may be different between the first side surface 140 and the second side surface 142 of the first ball-of-foot pad 14.

FIG. 6B shows a uniform thickness of 3-3 mm, which is used for average typical feet.

FIG. 6C shows the first side surface 140 having a thickness of 2 mm and the second side surface 142 having a thickness of 5 mm, with the left and right sides being asymmetrical.

FIG. 6D shows the first side surface 140 having a thickness of 2 mm and the second side surface 142 having a thickness of 7 mm, with the left and right sides being more asymmetrical. Typically, in the case of O-shaped legs, the weight of the leg is often placed on the outside of the foot, and thus, the pad is attached so that the portion facing the outside of the foot is the second side surface 142, and the portion facing the inside of the foot is the first side surface 140, thereby attaching so that the thickness is greater on the outside of the foot. Thereby, in the case of O-shaped legs, the wearer can feel a more comfortable and stable feeling rather than when using a uniform pad thickness. Conversely, typically, in the case of X-shaped legs, since the weight of the legs is often concentrated on the inner side of the feet, the portion facing the inner side of the foot becomes the second side surface 142, and the portion facing the outer side of the foot becomes the first side surface 140, so that it is attached in such a way that the inner side of the foot has a greater thickness. In the case of X-shaped legs, the wearer can feel a more comfortable and stable feeling rather than when using a uniform pad thickness.

In the present invention, if the first ball-of-foot pad 14 can be easily attached and detached, for example, using an adhesive or a fiber-based entanglement structure or embossing, the purchaser may attach the first ball-of-foot pad 14 by reversing the left and right sides while adding 180 degree rotation. In other words, the first ball-of-foot pad 14 has the advantage of being usable for both O-shaped and X-shaped legs. Thus, the first ball-of-foot pad 14 of the present invention has the versatility of being applicable to both normal and abnormal feet.

Next, the second ball-of-foot pad 16 of the present invention shares the characteristic structure and function of the first ball-of-foot pad 14, while slightly differing in shape. Like the first ball-of-foot pad 14, it is versatile and can be applied to a wide range of conditions, both normal and abnormal.

Next, the first heel pad 18 of the present invention also shares the characteristic structure and function of the first ball-of-foot pad 14. However, the thickness may vary slightly, ranging from 2 mm, 4 mm, and 6 mm. A uniform thickness of 2-2 mm is used for normal feet. Further, in the case of O-shaped legs, the outer side of the foot is attached with a thicker thickness as described above, and in the case of an X-shaped legs, the inner side of the foot is attached with a thicker thickness.

The pads of the present invention, particularly the pads on the lower surface having a heel function, can be modified in various ways.

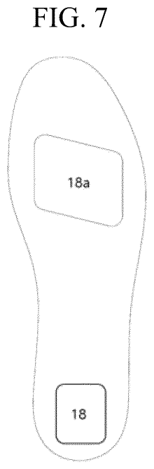

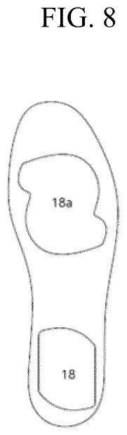

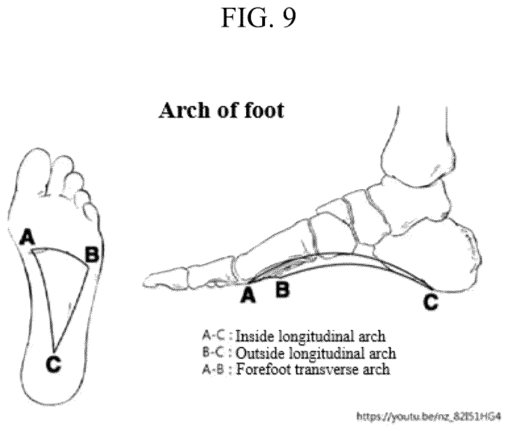

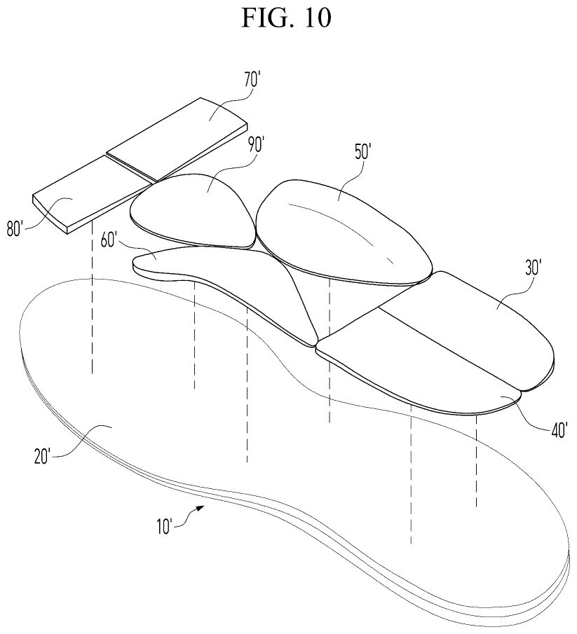

FIG. 7 is a diagram showing an embodiment in which a first heel pad 18 and a foot width pad 18a are attached to the underside 3 of the insole 1 of the present invention at the height position of the ball of foot in the forefoot area. The ball-of-foot pad 18a is the same as combining the first ball-of-foot pad 14 and the second ball-of-foot pad 16 into a single unit as in the aforementioned embodiments. The shapes of the first heel pad 18 and the ball-of-foot pad 18a are both point-symmetrical with respect to the center point. Therefore, the user can easily use the first heel pad 18 and the ball-of-foot pad 18a by adding 180 degree rotation, reversing their left and right sides, so as to fit O-shaped and X-shaped legs. The first heel pad 18 and the ball-of-foot pad 18a can have a variety of shapes, including polygonal, circular, elliptical, and star-shaped, as long as they are point-symmetric.

FIG. 8 shows another embodiment of the first heel pad 18 and the ball-of-foot pad 18a. The insole in FIG. 8 also has a point-symmetric pad, and its shape differs slightly from that of the above embodiment, however, it can be rotated 180 degrees to reverse the left and right sides, and therefore can be expected to have the same effect as the aforementioned embodiments.

As long as the overall shape of each heel pad is point-symmetrical, it is possible to use a pad made by attaching multiple components.

Of course, only one of the first heel pad 18 and the ball-of-foot pad 18a may be attached to the lower surface 3 of the insole 1. When using only the first heel pad 18, the ball-of-foot pad 18a may be a pad with equal thickness on both sides or a pad that is not point-symmetrical. Further, when using only the ball-of-foot pad 18a, the first heel pad 18 may be a pad with equal thickness at the right and left sides or a pad that is not point-symmetrical.

The pads of the present invention described above are merely examples, and their shapes and dimensions do not limit the scope of the present invention. In particular, since shoe sizes vary depending on age and gender, the pads can also be appropriately modified in shape and size, if necessary.

It should be noted that in the present invention, the first heel pad and the ball-of-foot pad, which take the wearer's legs into consideration, are attached to the lower surface 3 of the insole 1. In the case of O-shaped and X-shaped legs, it is important to adjust the contact point of the lowermost end area of the shoe, where it ultimately comes into contact with the ground. Therefore, in consideration of this point, the present invention attaches a heel functional pad to the lower surface of the insole, rather than the upper surface. Furthermore, fixed type (non-reversible 180-degree position) first and second pads 10, 12 that can be used regardless of the leg position are attached to the upper surface 2 of the insole 1, and a heel function pad is attached to the lower surface 3, which reduces the sense of strangeness felt by the wearer after changing the pad position, compared to when the pad on the upper surface 1 had been changed.

Meanwhile, utilizing the principles of the present invention, a camera-based 3D side scanner can be used to examine the required area in the case of a leg with an ideal shape, enabling fabrication of customized pads. This would be useful for patients who require walking or rehabilitation exercises.

On the other hand, the applicant has filed numerous patent applications relating to vibration devices for shoes, and issued under, for example, Korean Patent No. 10-2557301, Korean Patent No. 10-2037241, Korean Patent No. 10-1978880, and the like. The basic principle is that magnets are fixed to the upper and lower surfaces of the casing, a vibration plate is mounted in the middle of the casing, and movable magnets are disposed at the ends of the vibration plate so that they face the magnets on the upper and lower surfaces, the upper and lower surfaces of each magnet are aligned with the same polarity to generate a repulsive force, which causes the vibration plate to vibrate in response to the wearer's movements, thereby applying vibrations to the soles of the feet and helping to improve blood flow. In the present invention, the vibration device can be disposed in the insole 1. The vibration device can be disposed on the first heel pad 18 of the insole 1, or attached in place of other pads, or placed in a position that does not overlap with any pads. Thereby, in addition to the structural advantages of the insole 1, the health-improving effects of applying a magnetic field and vibration can be further enhanced. The vibration device may be embedded within the insole 1, or a portion of its lower surface may protrude below the lower surface of the insole 1. The vibration device can be embedded inside the insole 1, or its lower surface can partially protrude below the lower surface of the insole 1.

Although preferred embodiments of the present invention have been illustrated and described, it is apparent that various modifications and changes may be made in these embodiments and the scope of the present invention extends to areas that are identical or equivalent to the claims set forth below.

What is claimed is:

1. An insole for shoes for improving health function, the insole comprising a flat base, and a support surface including a gently sloped portion extending integrally from the base, wherein:
a first pad is attached so that it overlaps with the inside longitudinal arch line at an intermediate point in the longitudinal direction of the support surface, from the inside edge to the sloped surface on the upper surface of the insole,
at least a boundary region between the base and the support surface is included toward the front of the foot on the upper surface of the insole, and a second pad is attached to the portion overlapping with the forefoot transverse arch line that connects the inside longitudinal arch end point and the outside longitudinal arch end point,
a ball-of-food pad is attached to the base of the lower surface of the insole,
the rear side of the support surface on the lower surface of the insole is formed with a first heel pad that supports the heel portion of the foot,
the ball-of-foot pad and the first heel pad have point-symmetrical graphics, and are attached such that the thickness of the first side surface of each pad differs from the thickness of the second side surface opposite to the first side surface, and thus, a thicker portion is positioned on the inner side of the foot and a thinner portion is positioned on the outer side of the foot, or due to 180 degree rotation, the thicker portion is positioned on the outer side of the foot and the thinner portion is positioned on the inner side of the foot, thereby enabling the ball-of-foot pad and the first heel pad to be used without replacing or adding pads in accordance with the body type of O-shaped or X-shaped legs.

2. The insole according to claim 1,
wherein a lattice-shaped reinforcement portion composed of curved horizontal ribs and curved vertical ribs is formed at an intermediate region from the support surface on the lower surface to the portion where the first heel pad is located.

3. The insole according to claim 2,
wherein the first pad and the second pad have a structure in which the height is highest at the center and decreases toward the ends.

4. The insole according to claim 2,
wherein the insole is mounted with a vibration device, the vibration device is configured such that magnets are fixed to the upper and lower surfaces of the casing, a vibration plate is mounted in the middle of the casing, and movable magnets are positioned at the ends of the vibration plate so that they face the magnets on the upper and lower surfaces, the upper and lower surfaces of each magnet are arranged with the same polarity to generate a repulsive force, so that the vibration plate vibrates as the wearer moves, thereby applying vibrations to the soles of the wearer's feet and helping to improve blood flow.
